(19) United States
(12) Patent Application Publication
(10) Pub. No.: US 2002/0161793 A1
(43) Pub. Date: Oct. 31, 2002

(54) Retrieving information from web pages

(75) Inventor: Niclas Stahl, Montreal (CA)

Correspondence Address: ANDRE M. SZUWALSKI, Jenkens & Gilchrist, P.C., 1445 Ross Avenue, Dallas, TX, 75202-2799, US

(73) Assignee: Telefonaktiebolaget L M Ericsson

(21) Appl. No.: 09/840,997

(22) Filed: Apr. 25, 2001

(51) Int. Cl. G06F 7/00

(52) U.S. Cl. 707/500

(57) ABSTRACT

The invention relates to a new reference tag as an extension to mark-up languages, such as the HyperText Mark-up Language. The new reference tag embraces an item, such as a picture or a paragraph, and provides information about the item. The information can for example be the time when the item was updated. The reference tag may be used to download just one item amid several items in a document.

### BACKGROUND OF THE INVENTION

1. Technical Field of the Invention

The present invention relates to formatting and retrieval of information in documents located in computer networks, particularly the Internet.

2. Description of Related Art

The Internet is a well-known phenomenon used by millions of people every day. FIG. 1 shows a simplified block diagram of an exemplary network-browsing environment according to the Prior Art. Only those items needed for explanatory reasons are included in FIG. 1, but it should be understood that a real network is bound to comprise more nodes, connections and the like. A user desiring to access a web page 11 (also known as a document) located on the Internet 20 needs some kind of browser 10 to do so. Such a browser 10 may be a program residing in a device 21 such as for example a computer, a cellular telephone or a Personal Digital Assistant (PDA).

In the description hereinafter, “web page 11” may, where no risk of confusion exists, be used to describe the page as it is stored on a web site, the information, i.e. the HTML code, the executable files and so on, that make up the information in the page, and the web page as it appears to a user in a browser window. A person skilled in the art will certainly know what the term refers to at different times.

As well known in the art, the user enters in the browser 10 a Uniform Resource Locator (URL) or the like that identifies the desired web page 11. The browser 10 sends a request comprising the page identifier towards the network 17 through connection 15 to a modem 14 that in turn is connected to the network 17 through connection 16. These connections 15 and 16 may for example be electrical, optical or telephone cable connections, but the modem 14 may also be incorporated in the device 21 the browser 10 resides on. The device 21 may also have access to the network 17 through a wireless connection 19 using for example, but not limited to, one or more of the following technologies well known in the art: Time Division Multiple Access (TDMA), Code Division Multiple Access (CDMA), Wideband Code Division Multiple Access (WCDMA), Global System for Mobile Communication (GSM), Personal Digital Cellular (PDC), Total Access Cellular System (TACS), Code Division Multiple Access One (CDMAOne), Code Division Multiple Access 2000 (CDMA2000), and Bluetooth.

The network 17 then forwards the request to the server 12 that will provide the web page 11. The connection 18 between the network and the server 12 may be of a kind mentioned hereinbefore. It is to be understood that the web page 11 need not necessarily reside within the server 12; it is usually sufficient that the server 12 has access to the web page 11.

The server 12 then retrieves and sends the web page information through the network 17 to the device 21 that processes the web page information and presents the web page in the browser 10 so that the user can see, read and interact with it.

FIG. 2 shows an exemplary Prior Art web page 11 as a user can see it in the browser 10. The web page 11 may comprise a commercial banner 22 at the top of the page. Such a banner 22 is usually an advertisement for some company or service and sometimes helps to pay for the upkeep of the web site (not shown) where the web page 11 is located. The left side of the web page 11 is mainly a navigation bar 23, by which the user can access other web pages, some of which may be external to the web site. To the right of the navigation bar 23 are two text blocks 24 and 25 that contain text information that may be of interest to the user. Finally, to the right are shown two images 26 and 27 that may provide further interesting information in image form to the user.

If the web page 11 is the front page of a newspaper's site then the parts of the web page 11 may be as follows:

The commercial banner 22 may be the header with the name of the newspaper.

The navigation bar 23 may provide an easy way to access various parts of the newspaper, for example “politics”, “economy”, “sports”, “leisure”, “weather” and “comics”.

The first text block 24 may be the main news story.

The second text block 25 may be the main sports story.

The first image 26 may show how the stock exchange is doing (the smiling face indicating an upward trend).

The second image 27 may show the weather forecast (sun).

FIG. 3 shows exemplary Prior Art HyperText Mark-Up Language (HTML) code 30. The text that is underlined is the text that will be shown by the browser 10, while the rest are instructions for the browser 10.

At the top are three lines 31 containing formatting instructions that will arrange the following items in a table. The following three lines 32 relate to a single subject. They start out with a tag, <P>, indicating a paragraph break. The following line contains a tag, <B>, indicating that the following text “December 13, 9:30 in the cafeteria” should be displayed with a bold font, which in turn is followed by another tag, </B>, indicating that the bold font should not be used any longer, and a <BR>tag, indicating a line break. The third and last line contains text to be displayed: “Sankta Lucia: Glögg and Swedish buns will be served.”

Most HTML tags have an opening tag, e.g. <B>, and a corresponding closing tag, e.g. </B>, but there are exceptions such as for example <P>and <BR>hereinbefore.

The first three of the following four lines 33 are analogous to the three lines 32 above. The fourth line however starts and ends with tags relating to bold font. The <A href=. . . >and its corresponding </A>indicate that what is between them, “Info”, is a so-called hyperlink that will download and display the web page, “/lmc_home/lmcevents/noel_{—}20001103.doc”, that is indicated between the hyphens after the ‘href’ when the hyperlink is activated.

The last five lines 34 show the code for yet another subject that is formatted using the tags mentioned hereinbefore. A real web page may contain many more items than the three illustrated in FIG. 3. Presently, when users access a web site to download information the entire web page is downloaded. This way of downloading information wastes resources if the user only desired part of the information located on the web page. There is no efficient way for the user to download only part of a page. One way for the user to avoid the download of too much information is to manually stop the data transfer when the interesting information has been received. This is however cumbersome and requires constant attention from the user, and may still be futile if the desired information is the last to be received.

Some pages found on the Internet provide the possibility to find and display a certain subject, for instance by the use of Anchor tags in HyperText Mark-up Language (HTML), which is a common language used to format web pages. These Anchor tags require the entire web page to be downloaded, so while they facilitate the search for information for the user, they do not solve the problem of reducing the amount of transferred information.

Another problem facing the user is that if he on a regular basis wants to access several small pieces of information from several different web pages he has to access each of these pages in succession which is quite time consuming and annoying. There are web sites that let the user choose the information he wants displayed, but only as long as the information is found on the web site itself. There is however currently no easy way for a user to do this if he wants to access particular information from different web sites.

Yet another problem is that major amounts of data are transmitted across the world as the users access the Internet. Even though the transport capability is increased practically every day, there are still bottlenecks, for example modem connections and wireless connections. This will probably continue to be a problem far into, and possibly beyond, the foreseeable future. One root of this problem is that users sometimes download the same page more than once, since they want to see if some data has been updated. Even though they are only interested in seeing a part of the page (possibly displayed together with the other information on the page), they still have to download all of it, which may be quite wasteful. There is no current solution to this problem.

The present invention seeks to overcome the problems mentioned hereinbefore in providing a method, a system and a network node that allow users to download a specific part of a web page, to repeatedly access several pieces of information from different web pages in an easy manner, and a way to decrease the amount of transmitted data when users want to download a page more than once.

### SUMMARY OF THE INVENTION

The present invention is directed to a method for retrieving information stored in at least one document stored in a server in a network. The at least one document comprises at least one tag identifying at least one item in the document, and the at least one tag comprises item information. The network further has a connection to an application program. The method begins when the application program sends to the server a request comprising an identifier of at least one document and requested item information associated with the document. Upon reception of the request by the server, it extracts from the request the identity of the at least one document that is comprised in the request, and for each extracted document, further extracts the requested item information. The server then retrieves items whose item information matches the requested item information and sends the retrieved items to the application program.

The present invention is further directed to a system for retrieving information. The system comprises an application program and at least one server having access to the information stored in at least one document. The at least one document comprises at least one tag identifying at least one item in the document, and the at least one tag further comprises item information. The application program comprises a transmission unit for sending to a server a request comprising an identifier of at least one document accessible by the server and requested item information associated with the document, and a reception unit for receiving retrieved items sent from the at least one server. The at least one server comprises a reception unit for receiving the request from the application program, a processing unit for extracting document identifiers from the request, and for each document identifier extracted, further extracting the requested item information, and retrieving the at least one requested item, and a transmission unit for sending retrieved items to the application program.

The present invention is further directed to a server for retrieving information stored in at least one document accessible by the server. The at least one document comprises at least one tag identifying at least one item in the document, and the at least one tag further comprises item 30 information. The server resides in a network that further has a connection to at least one application program. The server comprises a reception unit for receiving from the application program a request comprising an identifier of at least one document and requested item information associated with the at least one document, and a transmission unit for sending retrieved items to the application program. The server further comprises a processing unit for extracting from the request the document identifier, and for each extracted document, further extracting requested item information associated with the document, and retrieving the at least one requested item.

The present invention is further directed to a method for continuous update of information to an application program in a network. The network further comprises an intermediate node and at least one server storing documents wherein at least some of the documents comprise at least one tag. Each tag identifies an item in the document and at least one tag comprises information about when the item was updated. The method starts by sending from the application program to the intermediate node a list comprising at least one item and a time associated with each item. The intermediate node then sends to the at least one relevant server at least one request for at least one item, the at least one request comprising the time associated with the item in the list. Upon reception of a request by a server, it retrieves any requested items that were updated after the associated time, and sends the retrieved items to the intermediate node. Upon reception of the retrieved items at the intermediate node, it updates the time for every received item in the list, using the time in the item's tag, processes received items for transmission to the application program, and sends the received items to the application program.

The present invention is further directed to a system, comprising an intermediate node and an application program in a network, for continuous update of information to the application program. The network further comprises at least one server storing documents wherein at least some of the documents comprise at least one tag. Each tag identifies an item in the document and at least one tag comprises information about when the item was updated. The application program is for sending to the intermediate node a list comprising at least one item and a time associated with each item, and receiving messages from the intermediate node. The intermediate node is for sending to the at least one relevant server at least one request for at least one item, the at least one request comprising the time associated with the item in the list, and receiving items from the at least one relevant server. Upon reception of an item, the intermediate node updates the time for the received item using the time in the item's tag, processes received items for transmission to the application program, and sends to the application program a message comprising the received items.

The present invention is further directed to a method for continuous update of information to an application program in a network. The network further comprises an intermediate node and at least one server storing documents wherein at least some of the documents comprise at least one tag. Each tag identifies an item in the document and at least one tag comprises information about when the item was updated. The method comprises steps of sending from the application program to the intermediate node a list comprising at least one item and a time associated with each item, sending by the intermediate node to the at least one relevant server at least one request for at least one item, the at least one request comprising the time associated with the item in the list and the address of the application program. Upon reception of a request at the relevant server, it retrieves any requested items that were updated after the associated time, sends the retrieved items to the application program, and sends a message comprising the identity of the retrieved items and the time they were last updated to the intermediate node. Upon reception of the message at the intermediate node, it updates the time for every received item in the list.

The present invention is further directed to a system for continuous update of information to an application program in a network. The system comprises in the network an intermediate node and at least one server storing documents wherein at least some of the documents comprise at least one tag. Each tag identifies an item in the document and at least one tag comprises information about when the item was updated. The intermediate node is for receiving from the application program a list comprising at least one item and a time associated with each item, sending to the at least one relevant server at least one request for at least one item, the at least one request comprising the time associated with the item in the list and the address of the application program, receiving from the at least one relevant server a message comprising the identity of the retrieved items and the time they were last updated, and upon reception of the message, updating in the list the time for every item in the message. The server is for receiving requests from the intermediate node, retrieving any requested items that were updated after the associated time, sending retrieved items to the application program, and sending a message comprising the identity of the retrieved items and the time they were last updated to the intermediate node.

The present invention is further directed to an intermediate node in a network, the intermediate node being for continuous update of information to an application program. The network further comprises at least one server storing documents wherein at least some of the documents comprise at least one tag. Each tag identifies an item in the document and wherein at least one tag comprises information about when the item was updated. The intermediate node comprises a reception unit for receiving from the application program a list comprising at least one item and a time associated with each item, and receiving from at least one server items sent in response to requests sent by the intermediate node. The intermediate node further comprises a transmission unit for sending requests to relevant servers for the item, the requests comprising the time associated with the item in the list, and sending messages comprising items to the application program. The intermediate node also comprises a processing unit for updating the time for the item in the list stored by the intermediate node upon reception of the item at the intermediate node.

The present invention is further directed to a method for display of information in a browser application program. The information is stored in at least one document accessible by at least one server accessible by the browser application program in a network. At least one of the documents comprises tags identifying at least one item in the document, and the user has stored in the browser application program a list comprising the identities of at least two documents or items. The method comprises steps of accessing the list by the browser application program, for each entry in the list, sending a request to the corresponding server, and upon reception of a response from a server, displaying the information.

The present invention is further directed to a browser application program for display of information. The information is stored in at least one document accessible by at least one server accessible by the browser application program in a network. At least one of the documents comprises tags identifying at least one item in the document, and the user has stored in a memory accessible by the browser application program a list comprising the identities of at least two documents or items. The browser application program comprises a processing unit for accessing the list, and displaying information received from the at least one server, a transmission unit for sending a request to the relevant server for each entry in the list, and a reception unit for receiving responses from servers.

### BRIEF DESCRIPTION OF THE DRAWINGS

A more complete understanding of the present invention may be had by reference to the following Detailed Description when taken in conjunction with the accompanying drawings wherein:

FIG. 1 shown hereinbefore depicts a simplified block diagram of an exemplary network-browsing environment according to the Prior Art;

FIG. 2 shown hereinbefore depicts an exemplary Prior Art web page;

FIG. 3 shown hereinbefore depicts exemplary Prior Art HTML code;

FIG. 4 depicts an extension to present mark-up languages;

FIG. 5 depicts a signal flow diagram of a preferred embodiment of a method for downloading information from a server according to the invention;

FIG. 6 depicts a signal flow diagram of a preferred embodiment of a method for downloading information from more than one server according to the invention;

FIG. 7 depicts a flow chart of a preferred embodiment of a method for repeated automatic update of information from a server according to the invention; and

FIG. 8 depicts a flow chart of a preferred embodiment of a method for repeated automatic update of information from a server according to the invention.

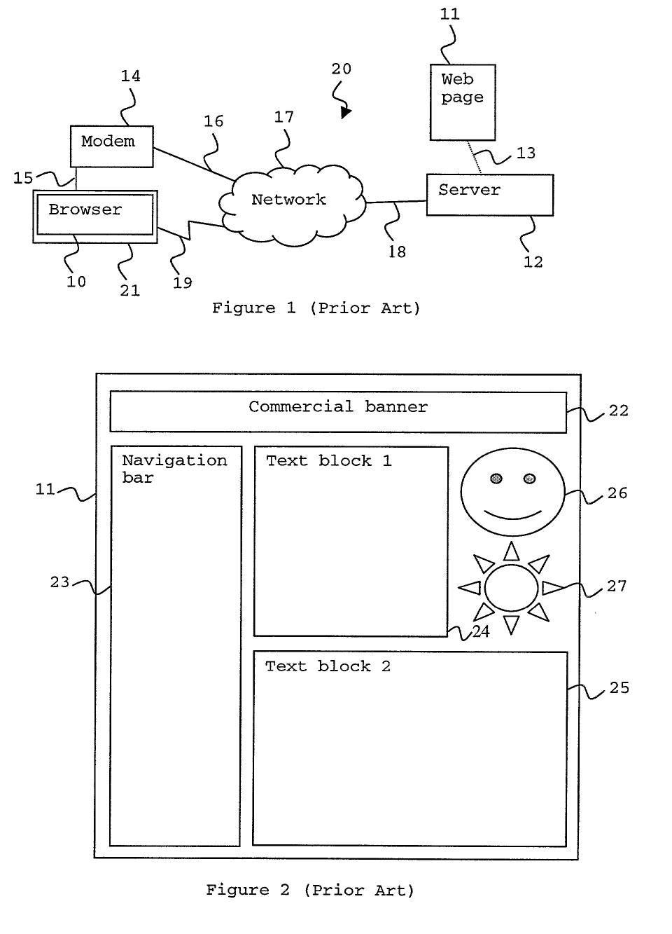

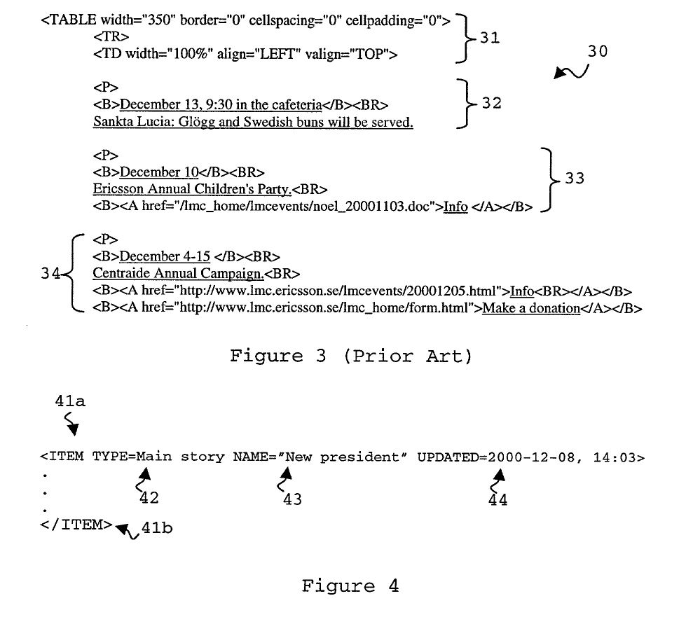

### DETAILED DESCRIPTION OF EMBODIMENTS

Reference is now made to the Drawings, where FIG. 4 depicts mark-up tags 41a and 41b (that may be referred to as 41 when both 41a and 41b are referred to jointly) that together form an extension to mark-up languages, existing and future. This new mark-up tag 41 is called ITEM and surrounds a subject or item of any kind. These items may for example be the main story of a newspaper, a stock ticker, an organisational chart, or a weather forecast. The new tag 41 may be used to indicate that everything within it is related, which is a main function of the tag.

The figure shows the start of the opening tag 41a “<ITEM” and its corresponding closing tag 41b “</ITEM>”. As mentioned hereinbefore, these two tags 41a and 41b surround what is considered to be one item, whether that item treats one or more subjects or topics completely, or a selected part of a subject. Encompassed in the opening tag 41a are a number of parameters 42-44 with information about the item. These parameters 42-44 indicate various aspects of the item, such as for example its type, name, and when it was last updated. The parameters that may be encompassed in the opening tag 41a are not limited to the three exemplary parameters 42-44 mentioned and shown, nor is any parameter mandatory.

The TYPE parameter 42 indicates the item's type. Examples of different types are ‘navigation bar’, ‘picture’, ‘applet’, ‘clock’, ‘stock ticker’, and as in the figure ‘main story’, the latter for example indicating that the particular item is the headline news story for the newspaper at the moment.

The NAME parameter 43 gives a hopefully unique name to the item. This may for example be used to distinguish different items from each other, and to help with the identification of a particular item. In the figure, the item's name is “New president”.

The UPDATED parameter 44 shows when the item was last updated. The exemplary item in the figure was updated (or added if the item is new) on Dec. 12, 2000 at 14:03. The level of detail is up to the author of the page, as it may be unnecessary to provide all the information to a user; for web pages that rarely are updated may need only the date, with or without year, while the time may suffice for web pages that are updated often, like for example stock quotes.

As already mentioned, other parameters may be used instead of or in addition to the parameters mentioned hereinbefore. Examples of such parameters are:

APPLICATION, that indicates that the item is only for use with the listed application or applications (such as for example certain browsers),

DELETE, indicating when the item should be removed from a web page,

CONNECTION, indicating options for the item depending on the kind of connection (e.g. modem, wireless or 56K) that the user accesses the web page with,

RESTRICTION, indicating the level of sensitivity of the material (e.g. PG, X, R, and Nudity),

NEXT UPDATE, indicating when the item will be updated the next time, and

UPDATE INTERVAL, indicating how often the item may be updated, such as every 15 minutes, possibly together with information on when the updates will stop and/or start.

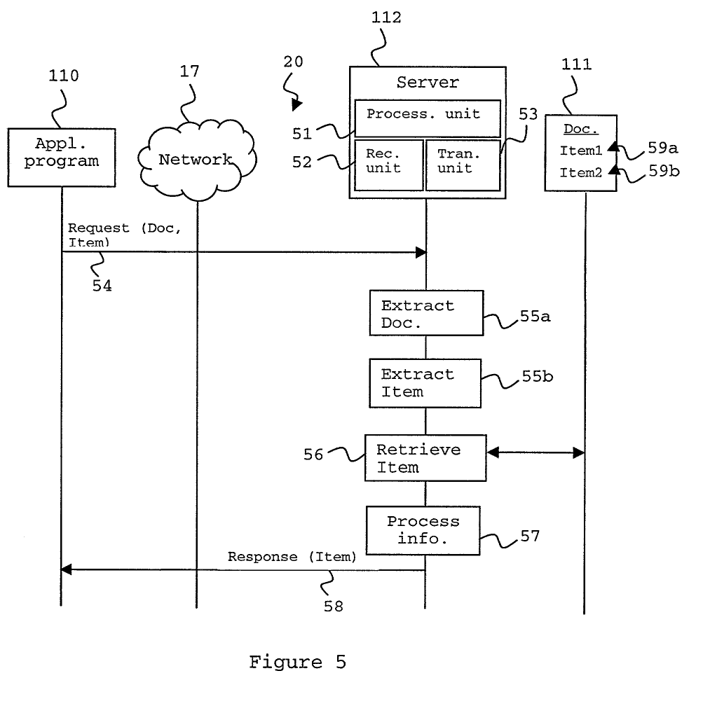

FIG. 5 depicts a signal flow diagram of a preferred embodiment of a method for downloading information from a server according to the invention. The Internet 20 is shown as an exemplary network, comprising an application program 110, a content server 112, and an interconnecting network 17. The application program 110 may be any kind of application or server that accesses information according to the method, whether for its own use or to relay to other applications. In the description of some of the embodiments hereinafter, the application program 110 will for exemplary purposes be a browser. The content server 112 has access to a document 111, comprising two items 59a and 59b (that may be referred to as 59 when the items are referred to together). For explanatory purposes, only one document is shown, but it should be understood that the server is likely to have access to a great number of documents. The content server 112 comprises a processing unit 51, a reception unit 52 and a transmission unit 53, the purposes of which will be explained hereinafter.

The method starts when a user uses the browser 110 to send a request 54 to the content server 112 through the interconnecting network 17, although the request could also be sent automatically, such as for example following some programmed rule. The request 54 may comprise at least one identifier to a document 111, and information about the at least one item 59 in the document 111 that is requested, in other words requested item information. The requested item information may be one or more of the parameters mentioned hereinbefore, each with one or more values where applicable; for example TYPE, requesting all items of a certain type, NAME, requesting items with a certain name, UPDATED, requesting items updated on or after a certain time.

The request 54 is received by the server's 112 reception unit 52, whereupon the request 54 is processed by the processing unit 51. The processing unit 51 extracts from the request 54 the identities of all the documents in the request 54, step 55a, and further extracts the requested item information for each document 111 extracted in step 55a, step 55b. The two steps 55a and 55b need not necessarily be performed in this sequence mentioned, they may also be intermingled, i.e. extract the identity of a first document, extract the requested item information for that document, extract the identity of a second document and so on.

The content server 112 then retrieves the items 59 that match the request, step 56. This may be done in various ways: one way is to retrieve directly only the items 59 that match. These items 59 are then delivered to the processing unit 51. If the document 111 is not located on the content server 112, then the transmission unit 53 and the reception unit 52 may be involved in the retrieval of the items 59. Another way to retrieve the relevant items 59 is for the processing unit 51 to request the entire document 111 and extract the items 59 that match a particular request 54.

The processing unit 51 may then process the retrieved items in step 57. This processing may add information comprising suitable labels to each item 59, in order to give enough information for the browser 110 to understand what the item 59 is, step 57. The processing may also remove information from the items, such as for example remove some of the parameters found in the opening tag. This step may be skipped if no additional information is needed, such as for example if only one item was requested, and if no information is to be removed. The items 59 are then passed to the transmission unit 53 that sends them in a response 58 to the browser 110 via the interconnecting network 17.

As can be induced from the method described in FIG. 4, the method can be used for updating information displayed by a browser 110, whether this information is from one or more than one document, something that will now be explained explicitly. In this case—still referring to FIG. 5—the browser 110 sends a request 54 to the server 112 via the interconnecting network 17. The request 54 comprises the identity of at least one document 111, wherein each document identity may be accompanied by at least one indication of a time. At least one indication of a time should be comprised in the request 54. Each document identity comprised in the request 54 may also be accompanied by information about requested items (apart from the time mentioned hereinbefore). If no item information is mentioned (apart from the time) it is assumed to be applicable to all items in the document.

The server 112 then extracts document identity and item information, including any times comprised in the request 54, steps 55a and 55b. The server 112 then retrieves the requested items 59, step 56, as explained hereinbefore. All the items 59 that are ‘new’to the browser 110, i.e. the items 59 that were updated on or after the relevant time comprised in the request 54, may be labelled in step 57 in order for the browser 110 to know the identity or relevance of the items 59. The items 59 are then sent in a response 58 to the browser 110 through the interconnecting network 17.

Many web sites rely on commercials displayed together with a document to provide the necessary revenues to keep the web site up and running. These commercials are often displayed in a predetermined place, such as in a banner at the top of the page, when the document is displayed. If the user of the browser only requests some items in the page it is possible that no such commercials are displayed together with the document, which is potentially disastrous for the provider of the web site. To remedy this problem, in step 57, extra information, such as for example commercial information, may be added inside the item 59 to be displayed by the browser 110. Extra information may be added to some or all the items 59 subsequently sent to the browser in step 58. As users may get annoyed if they receive the same extra information in several items 59 delivered from the same server 112, the server 112 may be set to add commercial information to only one or a few of the items 59 requested, and/or to add different extra information to some or all of the items 59. The extra information added in this manner need not necessarily be of commercial nature, although this may be the primary purpose of adding information as described hereinbefore. The information added may comprise any kind of information content providers wish distributed, such as for example security information, news, community information, and trivia. When, in the description hereinbefore, it is written ‘to be displayed by the browser’ et cetera, it is assumed that the information added is somehow to be made aware to the user of the browser, whether by text, video, picture, sound, smell, interactive programs and so on.

Although not explicitly stated hereinbefore, the request 54 from the browser 110 may comprise information such as APPLICATION, CONNECTION and RESTRICTION. In this case, the server 112 filters the items so that only items matching the value (in case of APPLICATION and CONNECTION) are retrieved in step 56. As for RESTRICTION, depending on implementation, the server 112 may retrieve the items either matching the RESTRICTION value or the items not matching the restriction value; the first case expressly allowing access, the second case expressly denying access. It is also possible for one parameter value implicitly to imply other parameter values, such as for example PG (Parental Guidance) implying G (General).

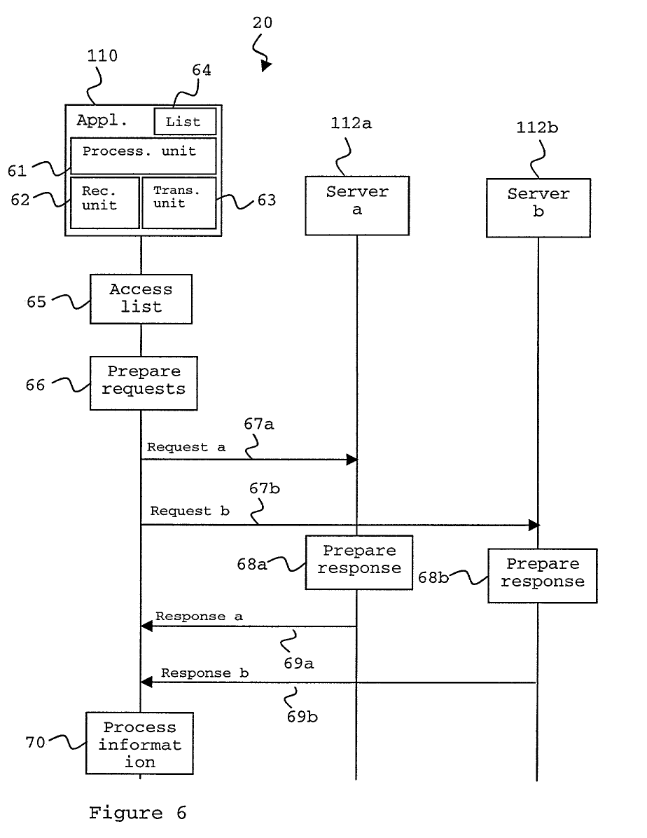

FIG. 6 depicts a signal flow diagram of a preferred embodiment of a method for downloading of information from more than one web site according to the invention. In FIG. 6 are shown an application program 110 (hereinafter referred to as an exemplary browser), and two content servers 112a and 112b (with the servers together referred to as 112), in a network 20 such as for example the Internet. The application program 110 comprises a processing unit 61, a reception unit 62, a transmission unit 63, and a list 64 comprising the identities of a number of documents accessible by at least two content servers 112. To simplify the figure, only two content servers 112 are shown in FIG. 6, but it is to be understood that the number of servers that can be accessed using the method may be far greater.

The method starts when the processing unit 61 accesses the list 64 in step 65. The list 64 is then used to prepare requests for information (referred to as 67 when referred to together or in general, and as 67a and/or 67b when referred to separately) that are sent by the transmission unit 63 to the proper information providers, such as for example the content servers 112. At least one, although preferably just one, request 67 is sent to each of the content servers 112 in the list 64, and thus one request 67a is sent to content server 112a and one request 67b is sent to content server 112b. Upon reception of a request 67, each of the servers prepares a response 69 (referred to as 69 when referred to together or in general, and as 69a and/or 69b when referred to specifically) as detailed hereinbefore in FIG. 5; steps 68a and 68b. The responses 69a and 69b are then sent to the browser 110 where they are received by the reception unit 62.

It is to be understood that the requests 67 may reach the content servers 112 at different times, depending on for example the distance, that the time it takes until the responses to the requests 67 are prepared may be different, and that the times for the responses 69 to reach the browser 110 may be different. For this reason, the responses 69 may reach the browser 110 in a different order than the order shown in FIG. 6.

Upon the reception of the responses 69 at the browser 110, the information may need to be treated or processed in order to be displayed in a useful manner, step 70. The simplest way to do this is to display the information as it reaches the browser 110, and simply link all the received information, relating to the same list 64 or having a common subject or link, into one long document. It is however probably more useful for the user to have the information displayed in a more logical manner. This can for instance be achieved by displaying the information in the order it was listed in the list 64.

There may also be formatting information available for the browser 110, for example provided in the list 64. This formatting information gives instructions on how to display the information, such as for example by providing areas within which the display of a certain item is to be displayed. Some items may be larger than the display space allotted to them in the formatting instructions. In this case, there are several different approaches to choose between. The first choice is simply to display as much as possible within the given boundaries, ignoring the fact that part of the item will be unavailable to the user. A second choice is to add scroll bars on the relevant sides of the display area. A third approach is to display a diminished item, that may be shown in its original size, either when the cursor or the like rests over the item, or for instance when user clicks on the item. Yet another approach is to display as much as possible of the item and add an indication that the item was truncated and a link to the fullsize version of the item; e.g. “. . . More>” in the lower right-hand corner.

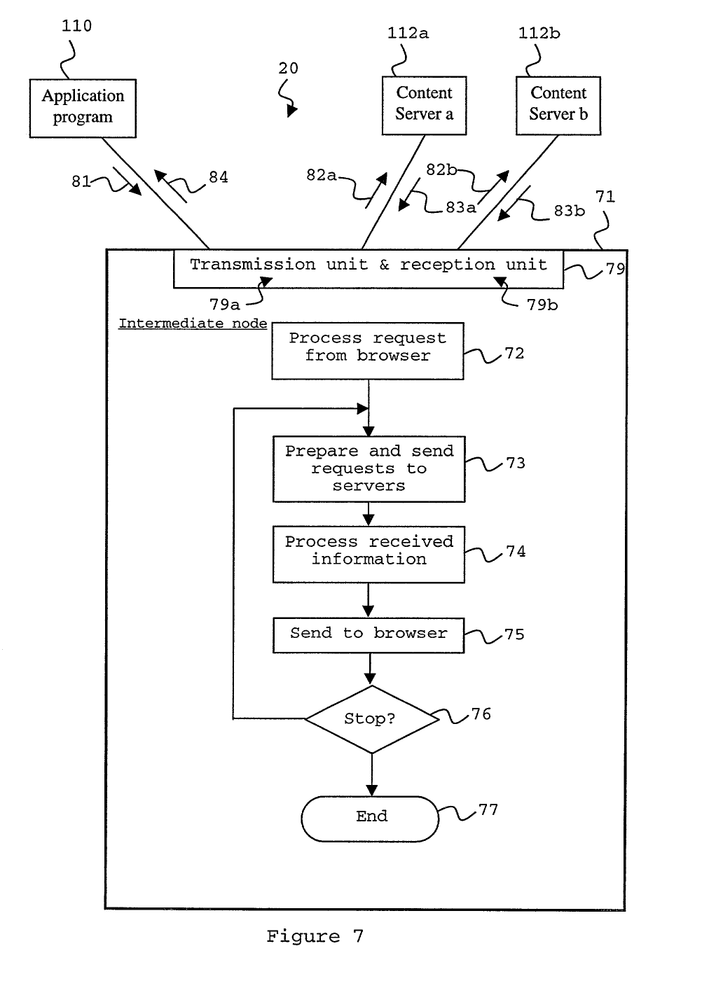

FIG. 7 shows a flowchart of a preferred method for repeated automatic update of information at the browser via an intermediate node according to the invention. Connected to the Internet 20 are an application program 110, such as an exemplary browser, content servers 112a and 112b (referred to as 112 when referred to together) and an intermediate node 71 comprising a transmission unit 79a and a reception unit 79b often co-located in a communication unit 79. The browser 110 sends a request 81 to the intermediate node 71 indicating the information the browser 110 desires to have updated repeatedly. The request 81 comprises the identity of the web pages and the items that are of interest, the time the items residing in the browser were last updated, and the request 81 may further comprise information on how often new updates are desired and when the browser desires the updates to stop and possibly resume.

The intermediate node 71 then processes the request 81 in step 72. This comprises receiving and storing the request 81, and analysing the request 81 as to when the information should be requested from the content servers 112. In addition the request 81 may possibly be rearranged to facilitate further handling, such as grouping the information according to content server 112 and/or the time when the information should be requested.

At the proper time, the intermediate node 71 prepares requests 82, comprising the identity of the requested information and possibly the time it was last downloaded, to send to the content servers 112; step 73. An exemplary two requests 82a and 82b are prepared to be sent to the content servers 112a and 112b respectively, but it is to be understood that the number of requests depends on the content of the original request 81. This step may, especially for requests after the first request, comprise a period of waiting for the proper time to arrive before preparing the requests or sending the data to the content servers 112. This waiting period could for example be default in the intermediate node 71, possibly depending on the connection used by the application program 110. The waiting period could also be set using information in the received items, such information for example being the parameters NEXT UPDATE or UPDATE INTERVAL.

The content servers 112 respond to the request as described hereinbefore and send responses 83a and 83b to the intermediate node 71. The intermediate node 71 then processes the information received in the responses 83a and 83b; step 74. This processing may for instance be formatting of the information, gathering information from several responses into one message, waiting for all the requested information to arrive, adding of commercial information, filtering of nonauthorised information, removal of information, and so on. If the intermediate node 71 waits for all the requested information to arrive, it is usually equipped with a timer function in order to send the information it already received if, for instance, a content server is unavailable. In addition, the intermediate node 71 updates the stored information with the time that the information was last updated.

The intermediate node 71 then sends a message 84, comprising the received information, to the browser 110; step 75. The intermediate node then verifies to see if it should stop updating information; step 76. If so, the intermediate node 71 ends the method for that particular browser, step 77. If the method should continue, then the intermediate node 71 returns to step 73, Prepare and Send Requests to Servers. The step of verifying whether the method should be stopped is for explanatory purposes shown as step 76, although it could be performed anytime during the course of the method. This could for instance be the case if the intermediate node 71 from the browser 110 receives a direct instruction to stop executing the method, if the intermediate node 71 is unable to reach the browser 110, or if the intermediate node 71 receives notification that the browser 110 no longer is connected to the Internet 20.

The method described in FIG. 7 is particularly useful when the browser 110 is connected to the Internet 20 via a low bandwidth connection, such as for example a modem connection or an air interface in a mobile telephone network. If the browser 110 itself were to repetitively request updates, much traffic would go through the low bandwidth connection unnecessarily. According to the method however, the intermediate node 71, such as for example a Mobile Switching Centre (MSC) in a mobile telecommunication network, requests the updates and sends only the updated information to the browser 110, leading to a decreased use of the connection.

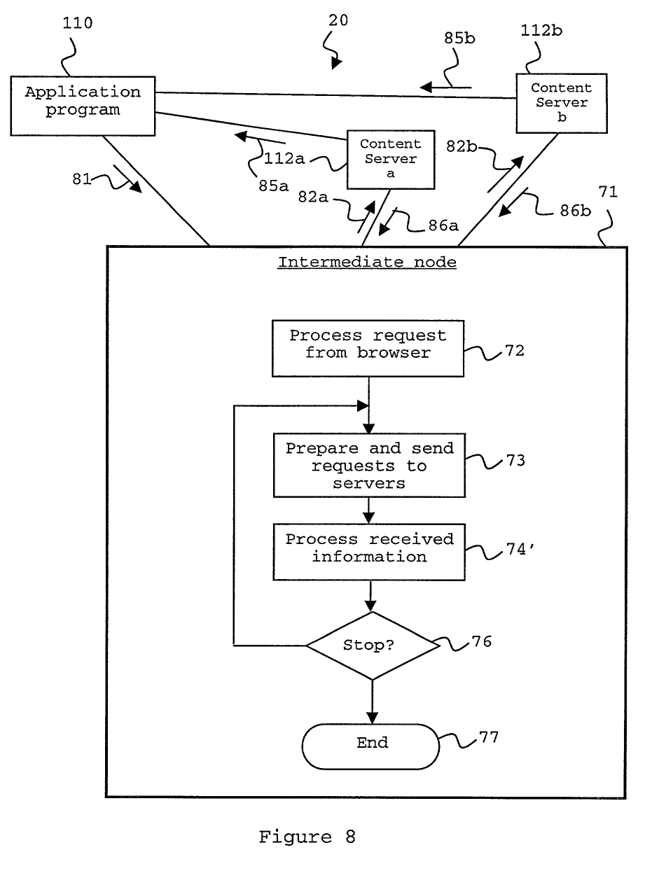

FIG. 8 shows a flowchart of another preferred method for continuous update of information at the browser via an intermediate node according to the invention. Connected to the Internet 20 are an application program 110, such as an exemplary browser, content servers 112a and 112b, and an intermediate node 71.

As described in FIG. 7, the browser 110 sends a request 81 to the intermediate node 71 that processes the request 81 from the browser 110; step 72. The intermediate node 71 then prepares and sends requests 82a and 82b to the content servers 12a and 12b. In this embodiment, the requests 82a and 82b comprise the address of the browser 110.

Upon reception of the requests 82a and 82b, the content servers 112a and 112b respectively retrieve the wanted information and send it directly in messages 85a and 85b to the browser 110, using the address received from the intermediate node 71. In addition, the content servers 112 send to the intermediate node 71 notifications 86 of when the transmitted items were updated. The intermediate node 71 then updates its data with the received information in step 74′.

The intermediate node 71 then verifies, as described hereinbefore, whether execution of the method should cease; step 76.

As this embodiment of the method requires the content servers 112 to send notifications 86 to the intermediate node 71, it is likely, although not necessary, that the intermediate node 71 and the content servers 112 belong to the same service provider.

Although several preferred embodiments of the methods, systems and nodes of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for retrieving information stored in at least one document stored in a server in a network, the at least one document comprising at least one tag identifying at least one item in the document, the at least one tag further comprising item information, the network further having a connection to an application program, the method comprising steps of:
sending from the application program to the server, a request comprising an identifier of at least one Kilo document and requested item information associated with the document;
upon reception of the request by the server:
extracting from the request the identity of the at least one document that is comprised in the request; and
for each extracted document, further extracting the requested item information;
retrieving items whose item information matches the requested item information; and
sending retrieved items to the application program.

2. The method according to claim 1, further comprising, after the step of retrieving the at least one requested item, the step of adding to at least one retrieved item extra information to be presented to a user.

3. The method according to claim 2, where the added information is commercial information.

4. The method according to claim 1, wherein the requested item information is the name of the item.

5. The method according to claim 1, wherein the requested item information is the type of the item.

6. The method according to claim 1, wherein the requested item information is the kind of application the item is intended for.

7. The method according to claim 1, wherein the requested item information is the kind of connection the item is intended for.

8. The method according to claim 1, wherein the requested item information comprises information on what kind of material is restricted by the application program.

9. The method according to claim 1, wherein the requested item information is the time when the item stored in the browser was last updated, and wherein the step of retrieving by the server the at least one requested item comprises retrieving the requested items that were updated on or after the given time.

10. A system for retrieving information, the system comprising an application program and at least one server having access to the information stored in at least one document, the at least one document comprising at least one tag identifying at least one item in the document, the at least one tag further comprising item information,
the application program comprising:
a transmission unit for sending to a server a request comprising an identifier of at least one document accessible by the server and requested item information associated with the document; and
a reception unit for receiving retrieved items sent from the at least one server; and
the at least one server comprising:
a reception unit for receiving the request from the application program;
a processing unit for
extracting document identifiers from the request;
for each document identifier extracted, further extracting the requested item information; and
retrieving the at least one requested item; and
a transmission unit for sending retrieved items to the application program.

11. The system according to claim 10, where the server's processing unit further is for adding to at least one retrieved item extra information to be presented to a user.

12. The system according to claim 10, where the extra information is commercial information.

13. The system according to claim 10, wherein the requested item information is the name of the item.

14. The system according to claim 10, wherein requested item information is the type of the item.

15. The system according to claim 10, wherein the requested item information is the kind of application the item is intended for.

16. The system according to claim 10, wherein the requested item information is the kind of connection the item is intended for.

17. The system according to claim 10, wherein the requested item information comprises information on what kind of material is restricted by the application program.

18. The system according to claim 10, wherein the requested item information is the time when the item stored in the browser was last updated, and wherein the step of retrieving by the server the at least one requested item comprises retrieving the requested items that were updated on or after the given time.

19. In a network, a server for retrieving information stored in at least one document accessible by the server, the at least one document comprising at least one tag identifying at least one item in the document, the at least one tag further comprising item information, the network further having a connection to at least one application program, the server comprising:
a reception unit for receiving from the application program a request comprising an identifier of at least one document and requested item information associated with the at least one document;
a processing unit for
extracting from the request the document identifier;
for each extracted document, further extracting requested item information associated with the document; and
retrieving the at least one requested item; and
a transmission unit for sending retrieved items to the application program.

20. The server according to claim 19, where the processing unit further is for adding to at least one retrieved item extra information to be presented to a user.

21. The server according to claim 20, where the extra information is commercial information.

22. The server according to claim 19, wherein the requested item information is the name of the item.

23. The server according to claim 19, wherein the requested item information is the type of the item.

24. The server according to claim 19, wherein the requested item information is the kind of application the item is intended for.

25. The server according to claim 19, wherein the requested item information is the kind of connection the item is intended for.

26. The server according to claim 19, wherein the requested item information comprises information on what kind of material is restricted by the application program.

27. The server according to claim 19, wherein the requested item information is the time when the item stored in the browser was last updated, and wherein the step of retrieving by the server the at least one requested item comprises retrieving the requested items that were updated on or after the given time.

28. A method for continuous update of information to an application program in a network, the network further comprising an intermediate node and at least one server storing documents wherein at least some of the documents comprise at least one tag, each tag identifying an item in the document and wherein at least one tag comprises information about when the item was updated, the method comprising steps of:
sending from the application program to the intermediate node a list comprising at least one item and a time associated with each item;
sending by the intermediate node to the at least one relevant server at least one request for at least one item, the at least one request comprising the time associated with the item in the list;
upon reception of a request by a server:
retrieving any requested items that were updated after the associated time; and
sending the retrieved items to the intermediate node;
upon reception of the retrieved items at the intermediate node:
updating the time for every received item in the list, using the time in the item's tag;
processing received items for transmission to the application program; and
sending the received items to the application program.

29. A system, comprising an intermediate node and an application program in a network, for continuous update of information to the application program, the network further comprising at least one server storing documents wherein at least some of the documents comprise at least one tag, each tag identifying an item in the document and wherein at least one tag comprises information about when the item was updated,
the application program is for:
sending to the intermediate node a list comprising at least one item and a time associated with each item; and
receiving messages from the intermediate node; and
the intermediate node is for:
sending to the at least one relevant server at least one request for at least one item, the at least one request comprising the time associated with the item in the list;
receiving items from the at least one relevant server;
upon reception of an item, updating the time for the received item using the time in the item's tag;
processing received items for transmission to the application program; and
sending to the application program a message comprising the received items.

30. A method for continuous update of information to an application program in a network, the network further comprising an intermediate node and at least one server storing documents wherein at least some of the documents comprise at least one tag, each tag identifying an item in the document and wherein at least one tag comprises information about when the item was updated, the method comprising steps of:
sending from the application program to the intermediate node a list comprising at least one item and a time associated with each item;
sending by the intermediate node to the at least one relevant server at least one request for at least one item, the at least one request comprising the time associated with the item in the list and the address of the application program;
upon reception of a request at the relevant server:
retrieving any requested items that were updated after the associated time;
sending the retrieved items to the application program; and
sending a message comprising the identity of the retrieved items and the time they were last updated to the intermediate node;
upon reception of the message at the intermediate node, updating the time for every received item in the list.

31. A system for continuous update of information to an application program in a network, the system comprising in the network an intermediate node and at least one server storing documents wherein at least some of the documents comprise at least one tag, each tag identifying an item in the document and wherein at least one tag comprises information about when the item was updated,
the intermediate node is for:
receiving from the application program a list comprising at least one item and a time associated with each item;
sending to the at least one relevant server at least one request for at least one item, the at least one request comprising the time associated with the item in the list and the address of the application program;
receiving from the at least one relevant server a is message comprising the identity of the retrieved items and the time they were last updated; and
upon reception of the message, updating in the list the time for every item in the message; and
the server is for:
receiving requests from the intermediate node;
retrieving any requested items that were updated after the associated time;
sending retrieved items to the application program; and
sending a message comprising the identity of the retrieved items and the time they were last updated to the intermediate node.

32. An intermediate node in a network, the intermediate node being for continuous update of information to an application program, the network further comprising at least one server storing documents wherein at least some of the documents comprise at least one tag, each tag identifying an item in the document and wherein at least one tag comprises information about when the item was updated, the intermediate node comprising:
a reception unit for:
receiving from the application program a list comprising at least one item and a time associated with each item; and
receiving from at least one server items sent in response to requests sent by the intermediate node;
a transmission unit for:
sending requests to relevant servers for the item, the requests comprising the time associated with the item in the list; and
sending messages comprising items to the application program; and
a processing unit for updating the time for the item in the list stored by the intermediate node upon reception of the item at the intermediate node.

33. A method for display of information in a browser application program, wherein the information is stored in at least one document accessible by at least one server accessible by the browser application program in a network, wherein at least one of the documents comprises tags identifying at least one item in the document, and wherein the user has stored in the browser application program a list comprising the identities of at least two documents or items, the method comprising steps of:
accessing the list by the browser application program;
for each entry in the list, sending a request to the corresponding server; and
upon reception of a response from a server, displaying the information.

34. A computer-readable storage medium having stored therein the instructions for causing a computer to perform the method of claim 33.

35. An electromagnetic signal comprising the instructions for causing a computer to perform the method of claim 33.

36. A browser application program for display of information, where the information is stored in at least one document accessible by at least one server accessible by the browser application program in a network, wherein at least one of the documents comprises tags identifying at least one item in the document, and wherein the user has stored in a memory accessible by the browser application program a list comprising the identities of at least two documents or items, the browser application program comprising:
a processing unit for
accessing the list; and
displaying information received from the at least one server;
a transmission unit for sending a request to the relevant server for each entry in the list; and
a reception unit for receiving responses from servers.
